(19) United States
(12) Patent Application Publication
(10) Pub. No.: US 2007/0274686 A1
(43) Pub. Date: Nov. 29, 2007

(54) Method and device for storing data

(75) Inventor: Gerardus Henricus Broeksteeg, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONIC, N.V., EINDHOVEN (NL)

(21) Appl. No.: 10/596,896

(22) PCT Filed: Jan. 6, 2005
(86) PCT No.: PCT/IB05/50068

§ 371 Date: Jun. 28, 2006

(30) Foreign Application Priority Data
Jan. 8, 2004 (EP) 04075002.8

(51) Int. Cl. H04N 5/76

(52) U.S. Cl. 386/108

(57) ABSTRACT

A method and a device for storing data on a storage device, such as a hard disc or DVD, representing video and/or audio signals and program information for broadcast channels. After a change of channel, the current program information of the new channel is displayed on the monitor. If a new change of channel occurs within 1 minute, the program information of the program of the channel is removed. If a change of program in the current channel occurs within 1 minute after the change of channel, the old program information is removed and replaced with the new program information after the change of program. If the current program information is identical with any previously stored program information, no new entry of the program information is performed.

### FIELD OF THE INVENTION

The invention relates to a method and a device for storing data on a storage device, such as a hard disc or DVD, said data representing video and/or audio signals and program information.

### BACKGROUND OF THE INVENTION

A combi recorder is a product or equipment that records analog or digital video and/or audio on a hard disk and offers options for archiving recorded programs (titles) to a DVD. Furthermore it may have extended time shift features and may support navigation in the past. Traditional analog video recorders cannot record and playback at the same time.

WO03/051030 discloses for example a combi recorder of the above-mentioned type having time shift functionality.

A user may want to zap between different channels to see what the other channels may offer. Such zapping may for example take place during sending of commercials in pauses in a movie. Normally, each zapping or shifting of channel means that the recorder starts to record from the new channel, and a new program information entry is inserted with relevant title data. While such zapping between different channels may take place rapidly, only a few seconds may be recorded of each channel. It may then be unnecessary or cumbersome to maintain all these title data, since the user anyhow most probably would not like to maintain such data.

The data may be edited by help of an editing bar. If the hard disk comprises a large amount of data, the editing bar may be very long and difficult to overview. It may be that the cursor that is moved along the editing bar takes a long time for running from one end of the bar to the other.

### SUMMARY OF THE INVENTION

Thus, there is a need for a management system in a combi recorder for handling such situations and aleviating the problems outlined above.

An object of the invention is to provide a management system in which unnecessary information during zapping may be removed and useful information may be maintained.

Another object of the invention is to provide an editing bar having facilities for displaying the editing bar on a monitor so that a good overview may be maintained and the cursor may move easily between the different parts of the bar.

These objects are achieved with a method and a device as defined in the appended patent claims.

According to a first aspect of the invention, there is provided a method of storing data on a storage device, such as a hard disc or DVD, said data representing video and/or audio signals and program information for at least one channel. The method comprises storing and/or displaying current program information of a new channel after a change of channel and hiding and/or removing said program information if a new change of channel occurs within a first time period.

In an embodiment, the hiding or removing of said program information takes place if a change of program in the current channel occurs within a second time period after said change of channel, whereupon the new program information is stored and displayed after said change of program.

In another embodiment, the current program information is compared with previously stored program information. If the current program information is identical with any previously stored program information, it is not stored and displayed again.

The first time period may be between 0.5 and 10 minutes, for example between 1 and 7 minutes, such as 2 minutes and the second time period may be between 0.5 and 10 minutes, for example between 1 and 7 minutes, such as 1 minutes. The first time period may be equally long as the second time period.

In yet another embodiment, the method further comprises displaying an editing bar comprising representations of video and/or audio signals and program information; and changing a resolution of said editing bar from a standard resolution of for example 10 to 60 seconds per pixel to an increased resolution of for example one second per pixel and vice versa A cursor may be moved along said editing bar with an accelerating speed. Moreover, chapter markings may be inserted at said editing bar at user defined positions.

In another aspect of the invention, there is provided a device for storing data on a storage device, such as a hard disc or DVD, said data representing video and/or audio signals and program information for at least one channel. The device comprises a display bar for displaying program information on a monitor; a means for displaying current program information on the monitor of a new channel after a change of channel; and a means for removing said program information from being displayed on the monitor, if a new change of channel occurs within a first time period.

In an embodiment, the device further comprises a means for removing said program information from being displayed on the monitor, if a change of program in the current channel occurs within a second time period after said change of channel; and a means for displaying the new program information on the monitor after said change of program.

The first time period may be between 0.5 and 10 minutes, for example between 1 and 7 minutes, such as 2 minutes and the second time period may be between 0.5 and 10 minutes, for example between 1 and 7 minutes, such as 1 minutes. The first time period may be equally long as the second time period.

In another embodiment, the device further comprises an editing bar comprising representations of video and/or audio signals and program information; and means for changing a resolution of said editing bar from a standard resolution of for example 10-60 seconds per pixel, to an increased resolution of for example one second per pixel and vice versa Moreover, chapter markings may be inserted at said editing bar at user defined positions.

In a further aspect, there is provided a product on a computer-readable medium having embodied thereon a computer program for performing the above-mentioned methods.

### BRIEF DESCRIPTION OF DRAWINGS

Further objects, features and advantages of the invention will appear from the following detailed description of embodiments of the invention with reference to the drawings, in which:

FIG. 1 is a screen dump and shows an example of a screen representation of a time shift buffer.

FIG. 2 is a screen dump similar to FIG. 1 and shows a further example of a screen representation of a time shift buffer.

FIG. 3 is a screen dump similar to FIG. 1 and shows a detailed screen representation of a time shift buffer.

FIG. 4 is a screen dump similar to FIG. 1 and shows a further example of a screen representation of a time shift buffer.

FIG. 5 is a screen dump similar to FIG. 1 and shows a further example of a screen representation of a time shift buffer.

### DETAILED DESCRIPTION OF EMBODIMENTS OF THE INVENTION

Some of the features of the combi recorder according to the invention are:

Continuous recording and time shifting

Simultaneous recording and playback

Title editing

Title playback

Faster than real time archiving to DVD

Automatic clean-up of the hard disk

Table of contents

All these features are outlined below.

Continuous Recording and Time Shifting

One key feature of the combi recorder is that it may always be recording. It can record from camera, but usually it records the live TV signal. The combi recorder may follow the zapping behaviour of the user and records what is being watched. The last n hours (n=1, 2, 3, 6) of what is being watched are recorded, allowing the user to save programmes afterwards. The set records into a so-called continuous buffer; the recorded material (say it is video only) flows into the buffer, while video that was recorded n hours ago will be discarded (flows out). Each zap and each programme change signal the beginning and end of a title in the continuous buffer. Programme changes may be reported by the EPG or by Teletext. Such information may also be retrieved from the Internet.

The continuous buffer is graphically presented on the screen as a bar with markers that indicate the title boundaries. Such a bar is called the Time Shift Bar or TSB. The TSB represents the last n hours of what was recorded. One pixel in the TSB may represent m seconds of recorded material (m=10, 20, 30 or 60 seconds). A playback pointer shows the position in the TSB in real time. Say that the TSB shows the recorded material from 16:00-19:00. When the playback pointer is positioned at 17:45, it indicates what was recorded at that time.

The TSB contains a number of titles, separated by title markers. The titles in the TSB have a certain color that reflects the genre (e.g. movie, sport, kids, etc).

The video being played back is shown behind the TSB. The TSB will disappear after a time out when the set is in normal play mode. With trick modes the TSB remains visible.

There are various ways in which the user can navigate in the TSB:

Jump to title markers using dedicated keys on the remote control.

Use the left/right arrow keys to navigate pixel-by-pixel. There is an algorithm that accelerates the movement of the playback pointer when a left/right arrow key is held down. The idea is to cover the entire buffer in a reasonable time.

Use the up/down arrow keys to select the previous or next title in the TSB.

Starting playback from the beginning of a title can be done with one (soft) key. Just position the playback pointer anywhere in the title and press “play from start”.

Titles can be saved (i.e. prevented from being lost when they fall off the buffer) by a single key press. Saving parts of a title can be done as well, but with multiple or long key presses.

The “Smart-OTR” feature marks successive titles in the TSB for saving with a repeated single key press.

When playing fast forward or otherwise navigating and the end of the TSB is reached, the system shows the live TV signal again (“catch-up” mechanism).

It is possible to show an extended overview of the TSB where the titles are listed in a vertical list. As the up/down arrow keys can be used there to navigate through that list, they can be used in the standard TSB as well.

A few words about zapping and title markers: when the user quickly zaps along channels and the set follows the zapping behaviour, then that would result in many very small titles that not only cannot be represented properly, but may also be useless to the user. Therefore, the title markers are only set if the set is tuned to the same channel for a certain period of time. A complicating factor may be the programme change information, provided by the EPG. Normally, a title marker would be inserted at each programme change. However, if the programme change occurs immediately after a zap, then that would also result in a very small title. Provisions have been taken to prevent that.

Similarly, if an extended TSB screen (overview screen) is shown which displays the details of the already recorded programs, then zapping immediately shows the full programme details. If the user zaps away within the time out period, the programme details are replaced, removed or hidden.

To complicate matters even further: when the users is on channel X and zaps to channels Y, Z and then back to X, no title marker is inserted; the system detects that it is now on the same channel.

In summary the combi according to the invention may provide the following features:

Setting the title markers when zapping quickly

Setting title markers when programme changes occur shortly after a zap

Showing and hiding full programme details in an extended overview when zapping quickly

Recognizing programmes after quickly zapping away and back

Accelerating arrow keys

Graphical representation of the continuous buffer (the TSB)

Marking programmes for saving, including Smart-OTR

When watching live TV, it is possible to review a scene, i.e. “rewind” while still continue recording

Simultaneous Recording and Playback

As the combi recorder is always recording, it is able to simultaneously record and playback. Playback in this context comprises:

Playing back a previously recorded title from hard disk

Playing back a (pre-recorded) DVD

Playing back a title that is still in the TSB

Playing back a title that is currently being recorded

Archiving a (batch of) title(s) from the hard disk to DVD

Title Editing

A title can contain chapters. A chapter may be nothing more than a part of a title. Chapters are separated by chapter markers. When recording a title, chapter markers can be added automatically, e.g. every five minutes or, more desirable, at every scene change in the footage. (When recording from a digital camera, the chapter markers are actually generated based on the recording dates and times.)

Title editing may comprise:

Changing the title name

Changing the genre (e.g. movie, sports, news, etc)

Adding a genre (e.g. for camera recordings)

Inserting and deleting chapter markers

Hiding and showing chapters

Selecting a key frame

Dividing the title in two parts

Changing the “seen” status of a title

Restoring the original title

Chapter markers can be inserted at any point in the title. Entire chapters (the part between two markers) can be “highlighted”, which means they are shown or hidden (i.e. not shown) when the title is played back.

A key frame is used to visually represent the title in the Table Of Contents (TOC). A key frame is selected automatically from the footage by the system, using a certain algorithm (similar to generating a key frame on DVD recorders). The user can select another screen shot as the key frame.

A title is marked as “seen” when it has been playing for more than a specific amount, such as 85% or a certain time period, e.g. 1 minute. This indication is used in automatic disk cleanup.

When editing, an editing bar is shown that represents the title. The chapter markers are shown and the chapters that are hidden are presented in a different color. When playing back the title, the video of the hidden sections is dimmed or is otherwise indicated as being “not shown during playback”. There is an algorithm to zoom in and out of the editing bar so that the resolution changes from 10-60 seconds per pixel to I second per pixel. Although the resolution of the editing bar is x seconds per pixel, it is still possible to find an exact screen shot by stepping through the video material. The arrow keys step one pixel, but e.g. when the video is paused, pressing the Pause key steps one frame.

Navigating in the editing bar can be done in the same way as with title playback.

Title Playback

A title, be it a previously recorded title or a title that is still in the TSB, can be played back. When playing back a title, the user is presented with a playback bar that represents the title. When chapters are hidden, then they are not shown in the playback bar and they are not played. It is as if those chapters do not exist. Chapter markers are shown in the playback bar.

Navigation in that playback bar comprises:

Jump to chapter markers

Skip a user-defined number of seconds (for example to skip the commercials).

Skipping forwards and backwards can be with different intervals.)

Move pixel-by-pixel and accelerate when the arrow key is held down

Move frame by frame, even though the resolution of the playback bar is 10 seconds per pixel at best

The normal trick modes: fast and slow forward and backward

A few words on jumping: when jumping to chapter markers or for a predefined number of seconds, the play mode is resumed. In other words, when the set was playing fast forward, then it resumes playing fast forward after a jump. That is the expected behaviour, but poses some problems when jumping against the play direction. Suppose the user is playing fast forward and presses “jump to previous marker”. Then the play mode would be resumed and the next “jump to previous marker” would go back to that same marker. There are several ways to circumvent that:

Pause the video for a predefined number of seconds before resuming the play mode. This gives the user time to repeat the command.

Skip the just visited marker when the same jump key is pressed again within a certain period of time.

Hold down the jump key and wait at each marker for a certain period of time.

This gives the user time to release the key in time.

Archiving

Archiving is the process of writing a (batch of) title(s) from the hard disk to a DVD. The user can indicate where the to-be-archived titles must be stored on the DVD, i.e. indicating which previously archived titles may be overwritten. Alternatively, the to-be-archived titles can be appended to the end of the DVD. The system will find out if there is enough space on the DVD before the archiving starts. When archiving is in progress, an OSD indicates how much longer the process takes, i.e. it counts down to 0, at which time the archiving process is estimated to be completed. In the mean time, the user can watch the live TV signal and can zap, but cannot usually time shift. Time shifting would mean playing back two titles simultaneously: one from the time shift buffer and the one that is being archived.

Cleanup of the Hard Disk

If the set runs out of disk space, it automatically deletes titles from the hard disk. The algorithm used is that the oldest titles are deleted first, starting with the titles that have already been watched by the user (“seen” property). Titles can be protected from deletion by setting them to “protected” from the Table Of Contents.

Table of Contents

The Table Of Contents (TOC) is a list of titles that are on the hard disk. Titles that are still in the TSB and are marked for saving are also in the TOC.

Titles can be sorted in several ways:

Alphabetically

Chronologically (i.e. by recording date)

Last played

In the order in which they will be deleted

And the title list can be filtered in several ways by just showing the:

Protected titles

Titles with a certain genre

Unseen titles

Titles that will be deleted (the list is sorted chronologically as well) The filtered list could also be sorted with a user-defined method.

Titles have to be “selected” in the TOC and then an operation can be chosen by the user. Such operations include delete, archive, child lock, protect.

The combi recorder can be used as a replacement for the traditional VCR or DVD recorder because it has more sophisticated features.

Figures

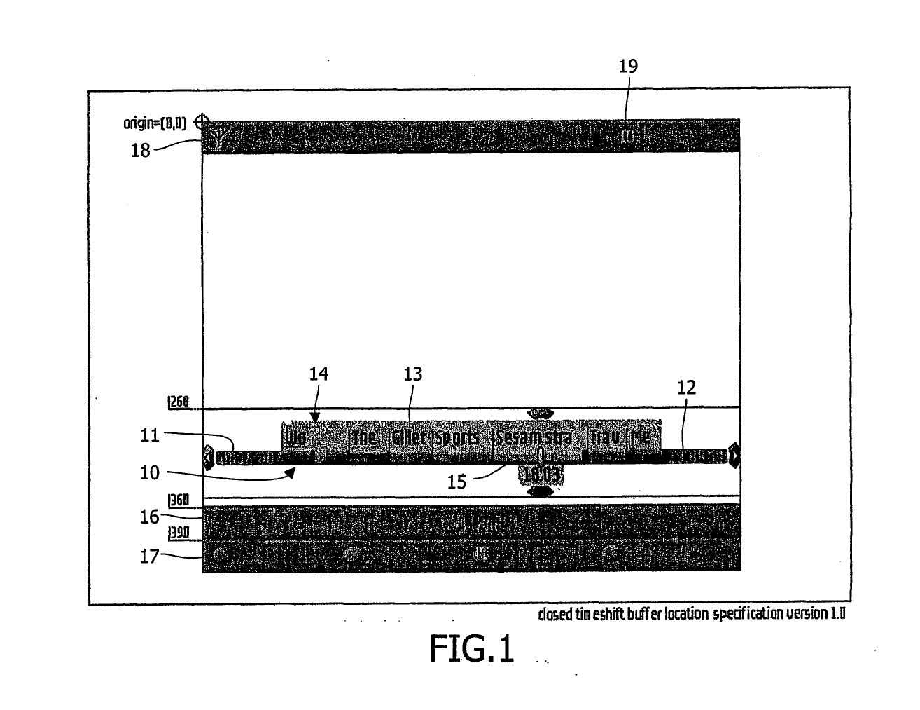

FIG. 1 shows an example of a screen with a TSB 10. To the left, at 11, the start time (16:00) of the TSB is shown and to the right, at 12, the end time (19:00) of the TSB is shown, which may be the actual time, or the time at which the TSB ends. In the present embodiment, the end time is always the actual time, since the combi recorder is always recording when it is on. The TSB 10 is divided into segments 13, each representing a program. Above the TSB is a field 14 indicating (part of) the title of the program, such as “Gillet (Sport magazine)”. A playback cursor 15 is shown in the middle of program “Sesam stra” at time 18:03, which is indicated under the playback cursor 15. Below the TSB 10, there are menu lines 16 and 17. Menu line 16 indicates different options such as [RETURN] [STOP] [RECORD] [PLAY]. The second menu line 17 indicates other options such as AUDIO I/II STOP REC PLAY FR ST (play from start) MORE INFO. These menu options may be selected by the user, for example by a remote control. The playback cursor may be moved to different positions on the TSB 10 and thereby select a specific program or playback position. A further menu line 18 is shown at the top of the screen including information about the program title indicated by the cursor, such as 03 NED 2 SESAMSTRAAT. Moreover, the menu line 18 includes a pause button 19.

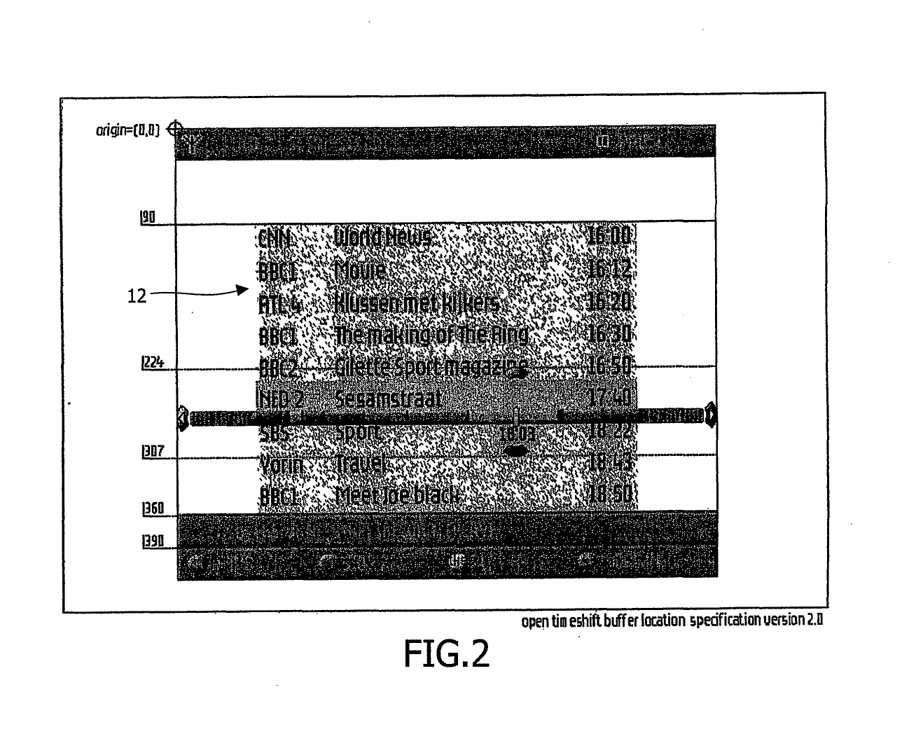

FIG. 2 is a screen similar to FIG. 1, but with extended information of the program titles. The programs are listed in a table 21, whereby the program indicated by the cursor is shown right above the TSB. Moreover, the start time of the recording of the program title is given in the table. Since the combi recorder normally always records, the end time of the title is the same as the starting time of the next program title. This real-time aspect is always maintained, even when the signal is lost. The recorder then records ‘nothing’, but stores it in the TSB anyway.

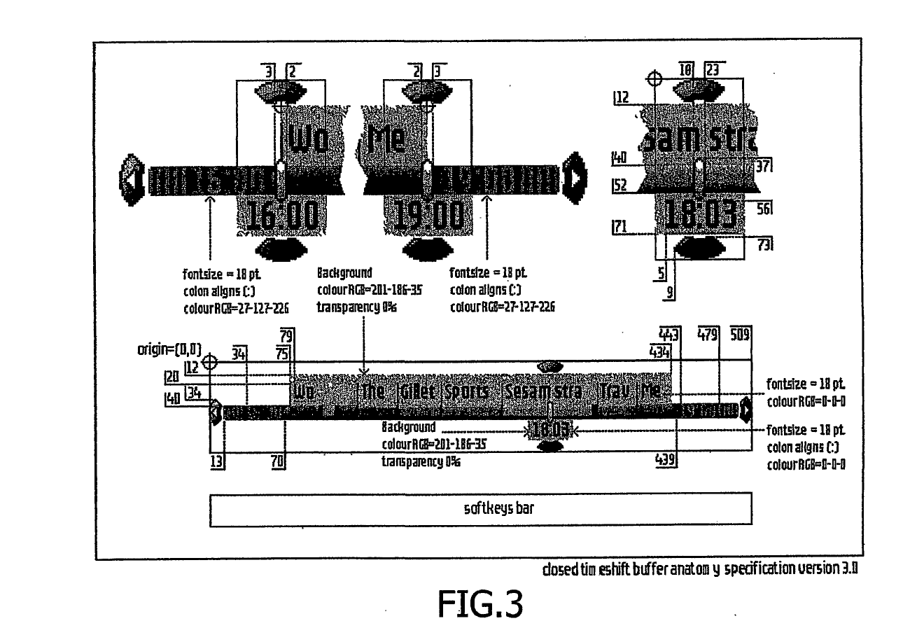

FIG. 3 shows the same details as in FIG. 1 in an enlarged scale.

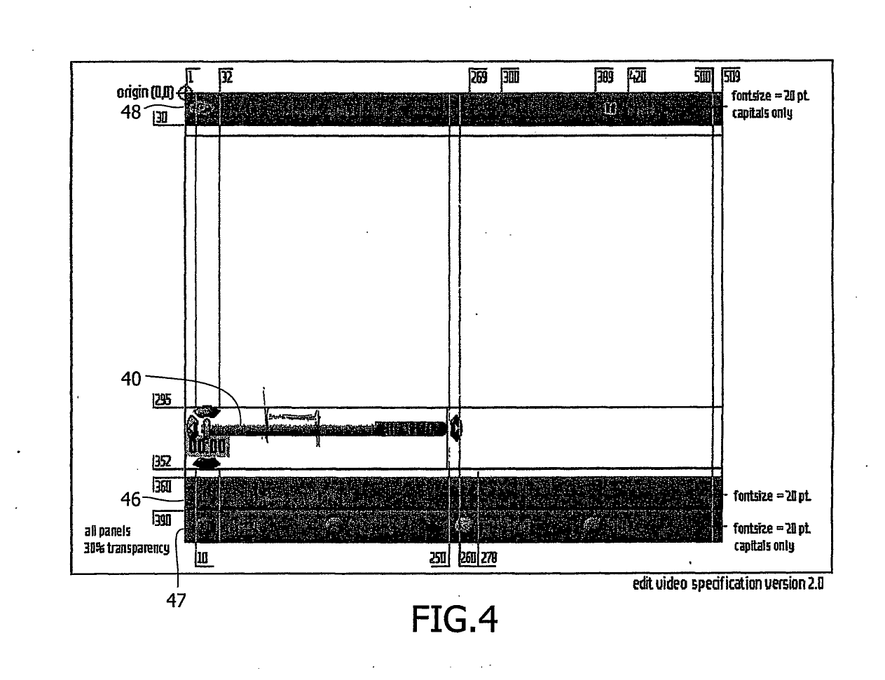

FIG. 4 shows an editing bar 40 for inserting a marker, such as a chapter marker in a program. The screen comprises an upper menu line 48 indicating RW SHREH EDIT MODE. Moreover, there are two menu lines 46 and 47. Menu line 46 comprises [OK]=insert marker and menu line 47 comprises DIVIDE MERGE APPEND HIDE.

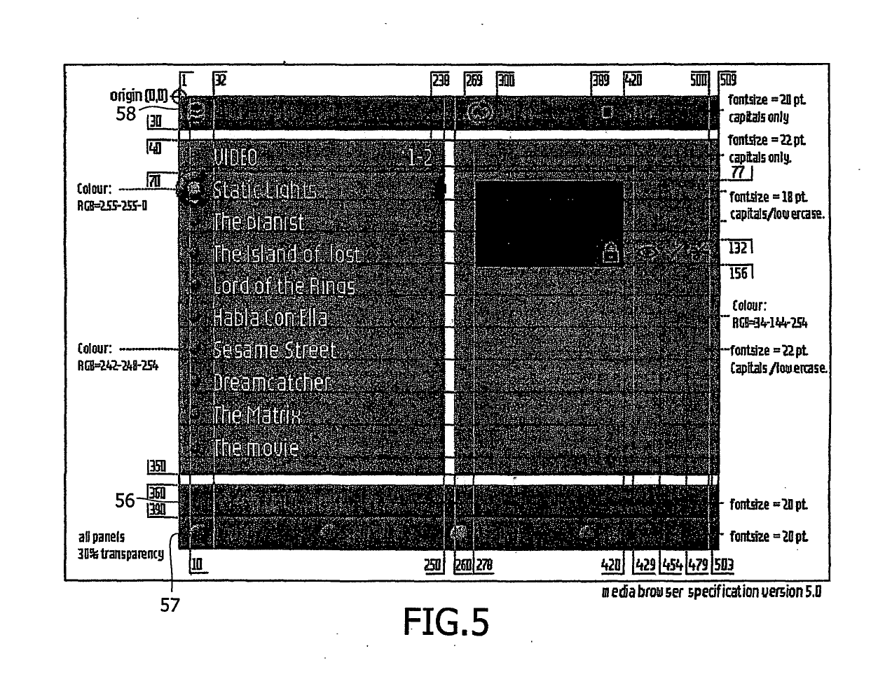

FIG. 5 shows another screen including a top menu line 58 comprising HDD VIDEO REPEAT STOP and two lower menu lines 56, 57 comprising PLAY EDIT OK=PLAY and SCAN SHUFFLE REPEAT REPEAT A/B.

Although the present invention has been described above with reference to specific embodiments, it is not intended to be limited to the specific form set forth herein. Rather, the invention is limited only by the accompanying claims and other embodiments than the specific above are equally possible within the scope of these appended claims.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A method of storing data on a storage device, such as a hard disc or DVD, said data representing video and/or audio signals and program information for at least one channel, comprising:
storing and/or displaying current program information of a new channel after a change of channel;
hiding and/or removing said program information if a new change of channel occurs within a first time period.

2. The method of claim 1, further comprising:
hiding or removing said program information if a change of program in the current channel occurs within a second time period after said change of channel; and
storing and displaying the new program information after said change of program.

3. The method of claim 1, further comprising:
comparing the current program information with previously stored program information and refraining from storing and displaying said current program information if the current program information is identical with any previously stored program information.

4. The method of claim 1, wherein said first time period is between 0.5 and 10 minutes, for example between 1 and 7 minutes, such as 2 minutes.

5. The method of claim 1, wherein said second time period is between 0.5 and 10 minutes, for example between 1 and 7 minutes, such as 1 minutes.

6. The method of claim 1, wherein the first time period is equally long as the second time period.

7. The method of claim 1, further comprising:
displaying an editing bar comprising representations of video and/or audio signals and program information; and
changing a resolution of said editing bar from a standard resolution of for example 10 to 60 seconds per pixel to an increased resolution of for example one second per pixel and vice versa.

8. The method of claim 7, further comprising:
moving a cursor along said editing bar and accelerating said cursor.

9. The method of claim 7, further comprising:
inserting chapter markings at said editing bar at user defined positions.

10. A device for storing data on a storage device, such as a hard disc or DVD, said data representing video and/or audio signals and program information for at least one channel, comprising:
a display bar for displaying program information on a monitor;
a means for displaying current program information on the monitor of a new channel after a change of channel; and
a means for removing said program information from being displayed on the monitor, if a new change of channel occurs within a first time period.

11. The device of claim 10, further comprising:
a means for removing said program information from being displayed on the monitor, if a change of program in the current channel occurs within a second time period after said change of channel; and
a means for displaying the new program information on the monitor after said change of program.

12. The device of claim 10, wherein said first time period is between 0.5 and 10 minutes, for example between 1 and 7 minutes, such as 2 minutes.

13. The device of claim 10, wherein said second time period is between 0.5 and 10 minutes, for example between 1 and 7 minutes, such as 1 minutes.

14. The device of claim 10, wherein the first time period is equally long as the second time period.

15. The device of claim 10, further comprising:
an editing bar comprising representations of video and/or audio signals and program information; and
means for changing a resolution of said editing bar from a standard resolution of for example 10-60 seconds per pixel, to an increased resolution of for example one second per pixel and vice versa.

16. The device of claim 10, further comprising:
chapter markings inserted at said editing bar at user defined positions.

17. A product on a computer-readable medium having embodied thereon a computer program for performing the method of claim 1.
